(19) United States
(12) Patent Application Publication
(10) Pub. No.: US 2018/0246346 A1
(43) Pub. Date: Aug. 30, 2018

(54) CONTACT LENS AND METHOD FOR MAKING THE SAME

(71) Applicant: HON HAI PRECISION INDUSTRY CO., LTD., New Taipei (TW)

(72) Inventor: HSIU-WEN CHIEN, New Taipei (TW)

(21) Appl. No.: 15/491,606

(22) Filed: Apr. 19, 2017

(30) Foreign Application Priority Data
Feb. 24, 2017 (TW) 106106492

(51) Int. Cl. G02C 7/04; B29D 11/00; G02B 1/04

(52) U.S. Cl. CPC G02C 7/049; B29D 11/00115; B29K 2105/0061; G02B 1/043; B29D 11/00134

(57) ABSTRACT

A contact lens comprises an inner surface, and an outer surface facing away from the inner surface. A water content of the contact lens increases from the outer surface to the inner surface. The disclosure also provides a method for making a contact lens.

### FIELD

The subject matter herein generally relates to a contact lens and a method for making the contact lens.

### BACKGROUND

Contact lenses are commonly worn by users to correct vision, or for cosmetic or therapeutic reasons. Since the contact lens directly contacts eyes of the user when in use, a high water content of the contact lens is needed.

### BRIEF DESCRIPTION OF THE DRAWINGS

Implementations of the present technology will now be described, by way of example only, with reference to the attached figures.

FIG. 1 is a cross-sectional view of an exemplary embodiment of a contact lens.

FIG. 2 is a flowchart of an exemplary embodiment of a method for making a contact lens.

FIG. 3 is a cross-sectional view of a mold used to make the contact lens of FIG. 1.

FIG. 4 is a cross-sectional view showing a female die and a male die of the mold core of FIG. 3 being engaged.

FIG. 5 is a flowchart of another exemplary embodiment of a method for making a contact lens.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. Also, the description is not to be considered as limiting the scope of the embodiments described herein. The drawings are not necessarily to scale and the proportions of certain parts may be exaggerated to better illustrate details and features of the present disclosure.

The term “substantially” is defined to be essentially conforming to the particular dimension, shape or other word that substantially modifies, such that the component need not be exact. For example, substantially cylindrical means that the object resembles a cylinder, but can have one or more deviations from a true cylinder. The term “comprising” when utilized, means “including, but not necessarily limited to”; it specifically indicates open-ended inclusion or membership in the so-described combination, group, series and the like.

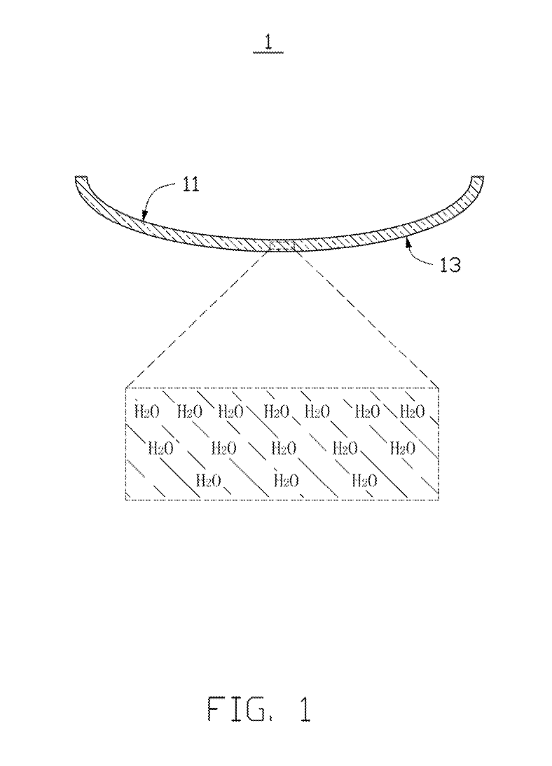

FIG. 1 illustrates an exemplary embodiment of a contact lens 1. The contact lens 1 comprises an inner surface 11 and an outer surface 13 facing away from the inner surface 11. The inner surface 11 is concave. The outer surface 13 is convex. When in use, the inner surface 11 contacts an eye of a user. A water content of the contact lens 1 increases from the outer surface 13 to the inner surface 11. Thus, the inner surface 11 having higher water content allows the user to feel more comfortable when in use. Furthermore, the outer surface 13 can block and prevent water of the inner surface 11 from evaporating.

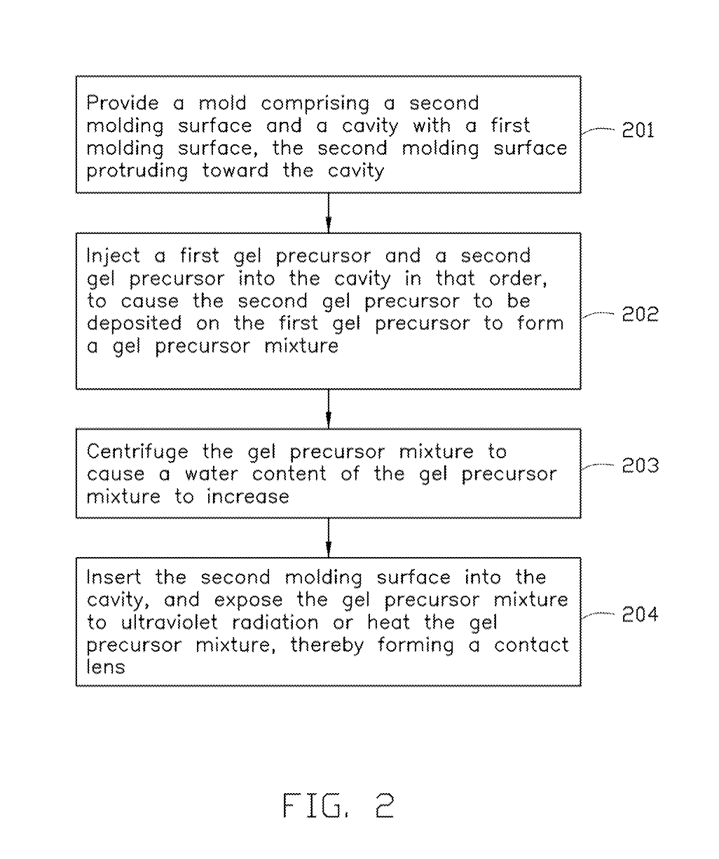

FIG. 2 illustrates a flowchart of a method for making a contact lens 1 in accordance with a first exemplary embodiment. The exemplary method is provided by way of example, as there are a variety of ways to carry out the method. Each block shown in FIG. 2 represents one or more processes, methods, or subroutines, carried out in the exemplary method. Furthermore, the illustrated order of blocks is by example only and the order of the blocks can change. Additional blocks may be added or fewer blocks may be utilized, without departing from this disclosure. The exemplary method can begin at block 201.

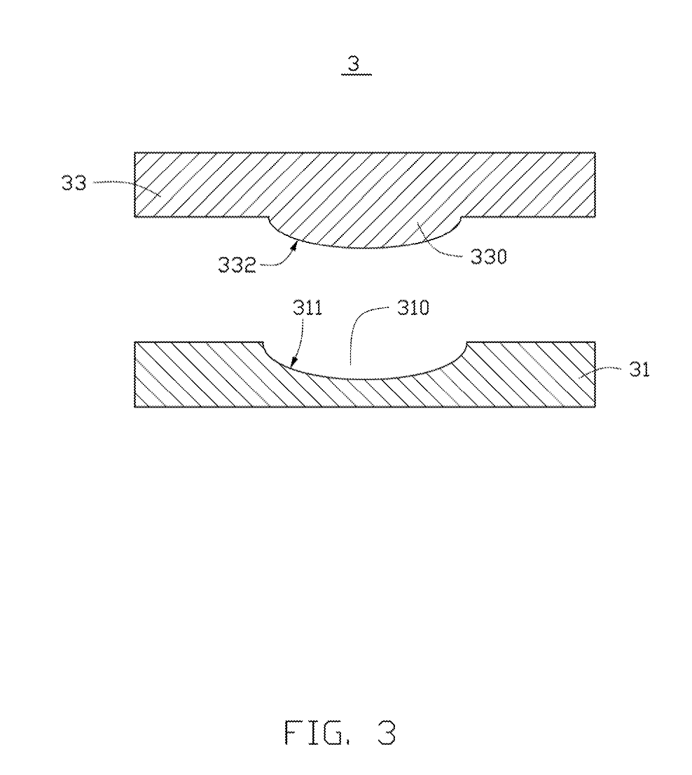

At block 201, referring to FIG. 3, a mold 3 is provided which comprises a female die 31 and a male die 33 matching the female die 31.

The female die 31 comprises a cavity 310. The cavity 310 comprises a first molding surface 311. The male die 33 comprises a mold core 330 protruding toward the female die 31 and matching the cavity 310. The mold core 330 comprises a second molding surface 332 protruding toward the female die 31.

At block 202, a first gel precursor is injected into the cavity 310, and then a second gel precursor is injected into the cavity 310 slowly which is deposited on the first gel precursor to form a gel precursor mixture. A ratio of the first gel precursor and the second gel precursor in volume can be varied according to need.

A water content of the first gel precursor is less than a water content of the second gel precursor. A density of the first gel precursor is larger than a density of the second gel precursor.

In at least one exemplary embodiment, the water content of the first gel precursor is in the range of about 25% to about 45%. The water content of the second gel precursor is in the range of about 50% to about 80%.

The first gel precursor and the second gel precursor are made of hydrogel or silicone hydrogel.

In at least one exemplary embodiment, the first gel precursor and the second gel precursor are both made of hydrogel or silicone hydrogel. In another exemplary embodiment, one of the first gel precursor and the second gel precursor is made of hydrogel, and the other one of the first gel precursor and the second gel precursor is made of silicone hydrogel.

Each of the first gel precursor and the second gel precursor comprises hydrophilic monomers, a cross-linking agent, an initiator, and a solvent.

The hydrophilic monomers may be selected from a group consisting of methacryloxyalkylsiloxanes, 3-methacryloxypropylpentamethyldisiloxane, bis(methacryloxypropyl)tetramethyl-disiloxane, monomethacrylatedpolydimethylsiloxane, mercapto-terminatedpolydimethylsiloxane, N-[tris(trimethylsiloxy)silylpropyl]acrylamide, N-[tris(trimethylsiloxy)silylpropyl]methacrylamide, tris(pentamethyldisiloxyanyl)-3-methacrylatopropylsilane (T2), 3-methacryloxypropyletris(trimethylsiloxy)silane, 2-hydroxyethylmethacrylate (HEMA), hydroxyethyl acrylate, hydroxypropyl acrylate, hydroxypropyl methacrylate (HPMA), trimethylammonium 2-hydroxy propylmethacrylate hydrochloride, dimethylaminoethyl methacrylate (DMAEMA), dimethylaminoethylmethacrylamide, acrylamide, methacrylamide, allyl alcohol, vinylpyridine, glycerol methacrylate, N-(1,1dimethyl-3-oxobutyl)acrylamide, N-vinyl-2-pyrrolidone (NVP), acrylic acid, methacrylic acid, and N,N-dimethyacrylamide (DMA), or any combination thereof.

The initiator may be a photoinitiator or a thermal initiator.

The photoinitiator may be selected from a group consisting of benzoin methyl ether, diethoxyacetophenone, a benzoylphosphine oxide initiator, ethyl 2-dimethylaminobenzoate, 2-isopropylthioxanthone, 1-hydroxycyclohexyl phenyl ketone, Darocur type initiator and Irgacur type initiator. In at least one exemplary embodiment, the photoinitiator is selected from Darocur-1173, Darocur-2959, and Irgacure-1173. The benzoylphosphine oxide initiator may be selected from a group consisting of 2,4,6-trimethylbenzoyldiphenylophosphine oxide, bis-(2,6-dichlorobenzoyl)-4-N-propylphenylphosphine oxide, and bis-(2,6-dichlorobenzoyl)-4-N-butylphenylphosphine oxide, or any combination thereof.

The thermal initiator may be selected from a group consisting of 2,2′-azobis (2,4-dimethylpentanenitrile), 2,2′-azobis (2-methylpropanenitrile), 2,2′-azobis (2-methylbutanenitrile), azobisisobutyronite (AIBN), and peroxides such as benzoyl peroxide, or any combination thereof.

The cross-linking agent may be selected from a group consisting of ethylene glycol dimethacrylate (EGDMA), trimethylolpropane trimethacrylate (TMPTMA), tri(ethylene glycol) dimethacrylate (TEGDMA), tri(ethylene glycol) divinyl ether (TEGDVE), and trimethylene glycol dimethacrylate, or any combination thereof.

In at least one exemplary embodiment, the solvent is glycerol. In another exemplary embodiment, the solvent may be tripropylene glycol methyl ether, cyclohexanol, or cyclopentanol.

At block 203, the gel precursor mixture in the cavity 310 is centrifuged, to cause a water content of the gel precursor mixture to increase from one side of the gel precursor mixture adjacent to the first molding surface 311 to the other side of the gel precursor mixture away from the first molding surface 311. That is, the water content of the gel precursor mixture emerges in gradient distribution from one side of the gel precursor mixture adjacent to the first molding surface 311 to the other side of the gel precursor mixture away from the first molding surface 311.

In at least one exemplary embodiment, the gel precursor mixture is centrifuged at a speed of about 20 rpm to about 500 rpm for a time period less than about 5 min. In the illustrated exemplary embodiment, the gel precursor mixture is centrifuged at a speed of about 150 rpm to about 200 rpm for about 1.5 min to about 4 min.

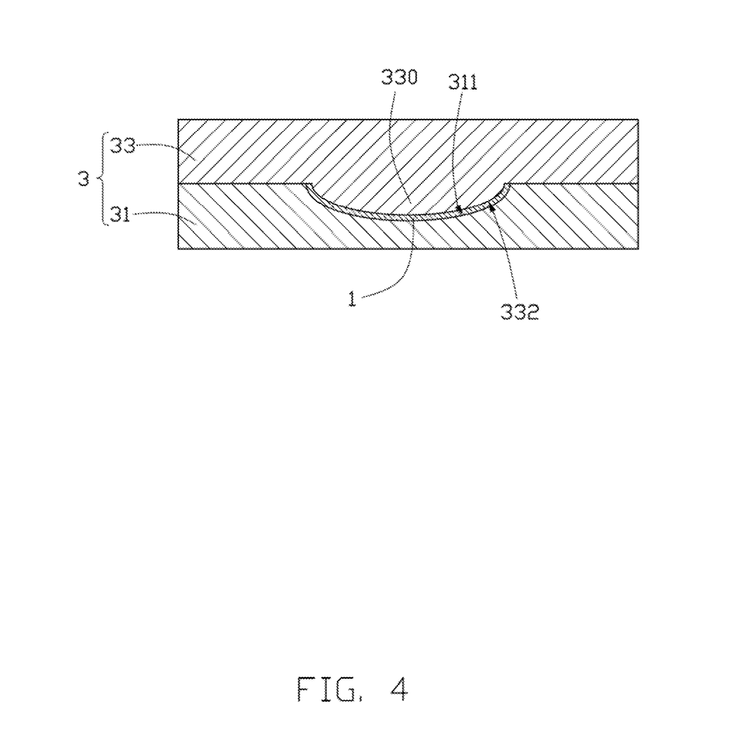

At block 204, referring to FIG. 4, the mold core 330 is inserted into the cavity 310, and the gel precursor mixture is exposed to ultraviolet radiation or is heated, to cause the gel precursor mixture to undergo a polymerization reaction, thereby forming the contact lens 1. When the gel precursor mixture is exposed to ultraviolet radiation, the mold 3 is made of a material which the ultraviolet radiation can pass through.

An outer surface 13 of the contact lens 1 faces to the first molding surface 311. An inner surface 11 of the contact lens 1 faces to the second molding surface 332. A water content of the contact lens 1 increases from the outer surface 13 to the inner surface 11.

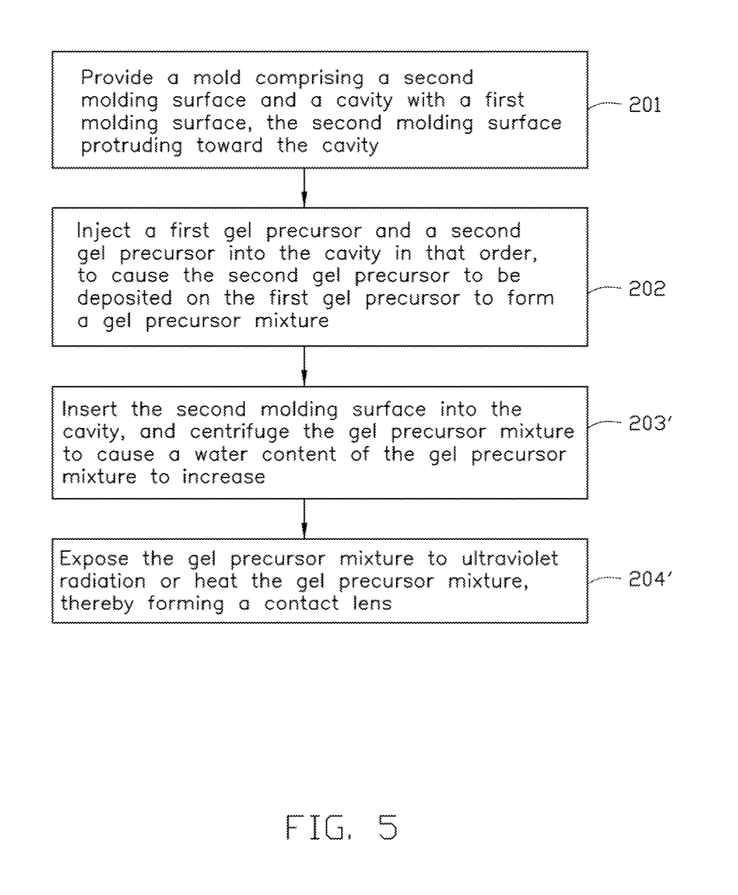

FIG. 5 illustrates a second exemplary embodiment of a method for making a contact lens 1. Difference between the second exemplary embodiment and the first exemplary embodiment is that the block 203 in the first exemplary embodiment is replaced by block 203′, and the block 204 in the first exemplary embodiment is replaced by block 204′.

At block 203′, the mold core 330 is inserted into the cavity 310, and the gel precursor mixture in the cavity 310 is centrifuged, to cause a water content of the gel precursor mixture to increase from one side of the gel precursor mixture adjacent to the first molding surface 311 to the other side of the gel precursor mixture away from the first molding surface 311.

In at least one exemplary embodiment, the gel precursor mixture is centrifuged at a speed of about 20 rpm to about 500 rpm for a time period less than about 5 min. In the illustrated exemplary embodiment, the gel precursor mixture is centrifuged at a speed of about 150 rpm to about 200 rpm for about 1.5 min to about 4 min.

At block 204′, the gel precursor mixture is exposed to ultraviolet radiation or is heated, to cause the gel precursor mixture to undergo a polymerization reaction, thereby forming the contact lens 1.

It is to be understood, even though information and advantages of the present embodiments have been set forth in the foregoing description, together with details of the structures and functions of the present embodiments, the disclosure is illustrative only; changes may be made in detail, especially in matters of shape, size, and arrangement of parts within the principles of the present embodiments to the full extent indicated by the plain meaning of the terms in which the appended claims are expressed.

What is claimed is:

1. A contact lens comprising:
an inner surface; and
an outer surface facing away from the inner surface;
wherein a water content of the contact lens increases from the outer surface to the inner surface.

2. A method for making a contact lens comprising:
providing a mold comprising a female die and a male die matching the female die, the female die comprising a cavity with a first molding surface, the male die comprising a second molding surface protruding toward the female die;
injecting a first gel precursor and a second gel precursor into the cavity in that order, to cause the second gel precursor to be deposited on the first gel precursor to form a gel precursor mixture, a water content of the first gel precursor being less than a water content of the second gel precursor, and a density of the first gel precursor being larger than a density of the second gel precursor;
centrifuging the gel precursor mixture to cause a water content of the gel precursor mixture to increase from one side of the gel precursor mixture adjacent to the first molding surface to another side of the gel precursor mixture away from the first molding surface; and
inserting the second molding surface into the cavity, and exposing the gel precursor mixture to ultraviolet radiation or heating the gel precursor mixture, to cause the gel precursor mixture to undergo a polymerization reaction, thereby forming the contact lens.

3. The method of claim 2, wherein the water content of the first gel precursor is in the range of 25% to 45%, the water content of the second gel precursor is in the range of 50% to 80%.

4. The method of claim 2, wherein the first gel precursor and the second gel precursor are both made of hydrogel or silicone hydrogel.

5. The method of claim 2, wherein one of the first gel precursor and the second gel precursor is made of hydrogel, and the other one of the first gel precursor and the second gel precursor is made of silicone hydrogel.

6. The method of claim 2, wherein the gel precursor mixture is centrifuged at a speed of 20 rpm to 500 rpm for a time period less than 5 min.

7. The method of claim 2, wherein the gel precursor mixture is centrifuged at a speed of 150 rpm to 200 rpm for 1.5 min to 4 min.

8. A method for making a contact lens comprising:
providing a mold comprising a female die and a male die matching the female die, the female die comprising a cavity with a first molding surface, the male die comprising a second molding surface protruding toward the female die;
injecting a first gel precursor and a second gel precursor into the cavity in that order, to cause the second gel precursor to be deposited on the first gel precursor to form a gel precursor mixture, a water content of the first gel precursor being less than a water content of the second gel precursor, and a density of the first gel precursor being larger than a density of the second gel precursor;
inserting the second molding surface into the cavity, and centrifuging the gel precursor mixture to cause a water content of the gel precursor mixture to increase from one side of the gel precursor mixture adjacent to the first molding surface to another side of the gel precursor mixture away from the first molding surface; and
exposing the gel precursor mixture to ultraviolet radiation or heating the gel precursor mixture, to cause the gel precursor mixture to undergo a polymerization reaction, thereby forming the contact lens.

9. The method of claim 8, wherein the water content of the first gel precursor is in the range of 25% to 45%, the water content of the second gel precursor is in the range of 50% to 80%.

10. The method of claim 8, wherein the first gel precursor and the second gel precursor are both made of hydrogel or silicone hydrogel.

11. The method of claim 8, wherein one of the first gel precursor and the second gel precursor is made of hydrogel, and the other one of the first gel precursor and the second gel precursor is made of silicone hydrogel.

12. The method of claim 8, wherein the gel precursor mixture is centrifuged at a speed of 20 rpm to 500 rpm for a time period less than 5 min.

13. The method of claim 8, wherein the gel precursor mixture is centrifuged at a speed of 150 rpm to 200 rpm for 1.5 min to 4 min.
